(19) United States
(12) Patent Application Publication
(10) Pub. No.: US 2002/0124049 A1
(43) Pub. Date: Sep. 5, 2002

(54) Method and apparatus for asynchronously pushing pages to browsers

(76) Inventors: Leonld Gorodetsky, Stony Brook, NY (US); Daniel D. Evans, Huntington, NY (US); Christopher F. Passaretti, Smithtown, NY (US)

Correspondence Address: COBRIN & GITTES, 21 floor, 750 Lexington Avenue, New York, NY, 10022, US

(21) Appl. No.: 09/823,357

(22) Filed: Mar. 30, 2001

Related U.S. Application Data
(63) Continuation-in-part of application No. 09/751,197, filed on Dec. 29, 2000.

(51) Int. Cl. G06F 15/16

(52) U.S. Cl. 709/203; 709/227

(57) ABSTRACT

A generic java applet which opens a connection to a web server allowing the web server to asynchronously push data to a browser. The java applet is embedded in a web page and loaded by the web browser with the web page. The java applet enables the web server to transmit any form of data to the browser so specialized java applets would be unnecessary. As the java applet is opened by the standard web browser, specialized software, or plug-ins, are unnecessary.

### CROSS-REFERENCE TO RELATED APPLICATIONS

This patent application is a continuation-in-part of U.S. patent application Ser. No. 09/751,197 filed Dec. 29, 2000.

### TECHNICAL FIELD

The present invention relates generally to the Internet and, more specifically, to using a generic java applet to asynchronously push information from a web server to a browser.

### BACKGROUND

The proliferation of the Internet has been well-documented. Today, most businesses have at least one connection to the Internet, and the same is true of many households. In addition, many companies have established Internet web sites, either as a preliminary storefront or as an alternative to the physical office.

The traditional method of exchanging information between a user and the web server is also well-known. When a user clicks a hyperlink on a web page, for example, the user's web browser “pulls” information from the web server. Typically, that information is a HypterText Markup Language (HTML) document, (e.g. another web page).

Many companies have found it to be beneficial, not only from their perspective but from the user's perspective as well, to be able to “push” information from the web server to the user's web browser. That is, the web server, independent of a request from the user, is able to send information to the user's browser for display. One example of this is a software program that provides continuous real-time stock quotes. As the price of the stock changes, the new price is automatically sent from the web server to the user and displayed in the user's browser.

Unfortunately, the proliferation of these applications, whereby the web server “pushes” information to a user's browser, has not been extensive. This is primarily due to the fact that such applications typically require specialized java applets which can open such a connection to the web server. As such, each company that wishes to push information from its web server to the user must develop a specialized java applet that is tailored to its specific information. Furthermore, special software, such as a browser plug-in, is typically required to run these specialized java applets.

It would be beneficial, therefore, to have a generic java applet which can be used by any company to push information to a user's browser. It would be further beneficial if such a java applet could work within a typical web browser without requiring additional, specialized software.

### SUMMARY OF THE INVENTION

The present invention provides methods and apparatus for asynchronously pushing information to a web browser.

According to an aspect of the invention, there is provided a method that includes embedding an applet in a web page. The web page and embedded applet are provided to a browser upon request from the browser. Subsequent to providing the applet to the browser, unsolicited information is provided to the browser.

According to another aspect of the invention, there is provided a system that includes a web page and a generic applet embedded within the web page. The generic applet is configured to allow unsolicited information to be pushed to a browser that downloads the web page.

According to still another aspect of the invention, there is provided a system that includes an applet module for opening a connection between a browser and a remote server. The system also includes a carrier module for communicating the applet to the browser. The applet module is generic to multiple dissimilar servers.

An aspect of the invention provides a method that includes embedding a Java applet in an Internet web page and providing the web page and the embedded applet to a browser upon request for the web page. The method further includes storing the applet in a memory associated with the browser, activating the applet and, subsequent to activating the applet, providing unsolicited information to the browser from a remote server. The method also includes closing the web page and deactivating the applet in response thereto.

The invention will next be described in connection with certain illustrated embodiments and practices. However, it will be clear to those skilled in the art that various modifications, additions and subtractions can be made without departing from the spirit or scope of the claims.

### DESCRIPTION OF THE DRAWINGS

The invention will be more clearly understood by reference to the following detailed description of an exemplary embodiment in conjunction with the accompanying drawings, in which:

FIG. 1 depicts a block diagram of an embodiment of the invention.

### DETAILED DESCRIPTION OF THE INVENTION

The present invention includes methods and apparatus for asynchronously pushing pages to a web browser.

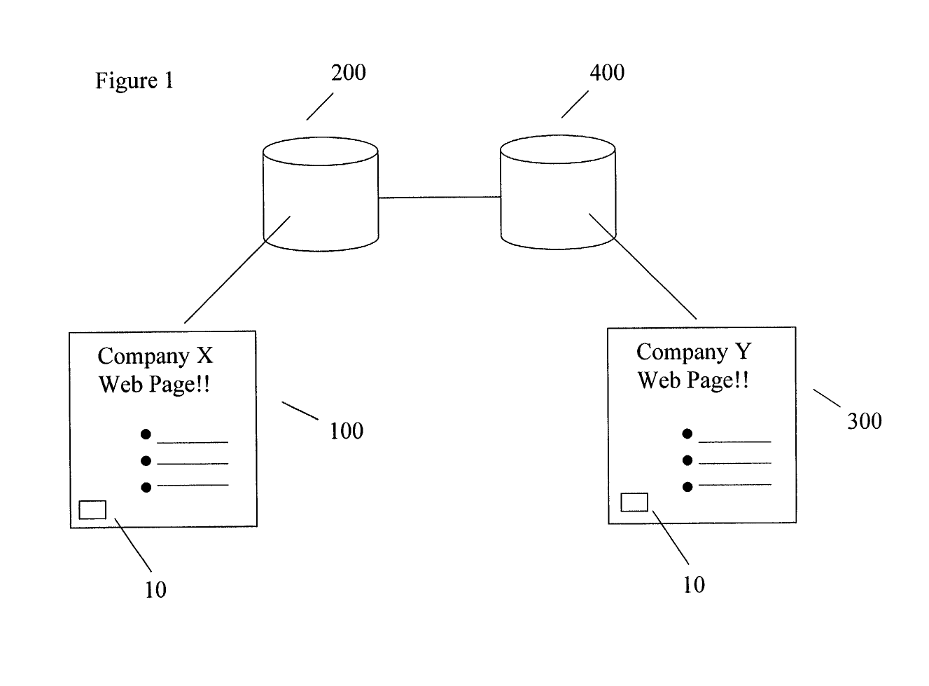

As illustrated in FIG. 1, a java applet 10 is embedded in a web page 100 or some other downloadable form. The web page 100 may be visited by users who are browsing the Internet with their Internet browsers, such as Microsoft Internet Explorer™ or Netscape Navigator™ or some other Internet browser. For exemplary purposes, the web page 100 of FIG. 1 is the web page of a specific company. While the developer of the web page knows of the existence of the java applet 10, the applet 10 may be hidden to the user (although not required to be). The web page 100 resides on a particular web server 200. The web server may be the developer's own web server, it may be a web server in which the company is currently leasing space, or it may be cached by another server.

Upon loading the web page 100, the user's browser will also load the hidden java applet 10, so long as the browser has not been configured to disable java applications as part of its security settings. The java applet 10 is a generic java applet, although it is not unreasonable to think that a merchant could modify the generic applet to be specific to that merchant in the configuration in which the applet is recopied to the browser each time it is sent. An example of such a generic java applet 10 can be found in Appendix 1 hereto. It will be noted, however, that the applet provided is illustrative only and not the only type of generic applet that can be developed. Thus, the current invention is not limited to the Java applet provided herein.

Once the web browser has loaded the java applet 10 into the memory of the user's computer, the java applet 10 is activated. Subsequently, a connection to the web server 200 or to some other server 200 may be opened so that the web server 200 or other server 200 may asynchronously push information to the web browser. For example, the web (or other) server 200 may push stock quotes, HTML documents such as web pages, Universal Resource Locators (URLs), etc. to the web browser.

If the user leaves the web page 100, the java applet 10 may be deactivated (It would still fall within the scope of the present invention if the applet remained active). This prevents the problem of spamming, whereby a web server may simply flood the user's web browser with unwanted information if the java applet connection remains open. If a company has multiple web pages, then, it would be possible to embed the java applet 10 in each web page so that the web server is capable of asynchronously pushing information to the user for as long as the user is at the company's web site. Also, it is possible to have the applet embedded in a frame set, in order to keep the applet active until the user leaves the web site entirely.

Since users often visit multiple web sites in a single on-line Internet session, a user may visit a second web page 300 residing at a different web server 400. This web page 300 may also have the generic java applet 10 embedded in it. If the browser detects the presence of the embedded java applet 10, the java applet 10 is reloaded and activated so that a connection is opened between the user's web browser and the web server 400. While a connection has once again been opened, the only web server that is capable of asynchronously pushing data to the browser is the web server which hosts the web page that caused the java applet 10 to be activated. In this case, web page 400 caused the java applet 10 to be activated so a connection is established with web server 400.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope of the invention which, as a matter of language, might be said to fall there between.

APPENDIX 1
import java.io.*;
import java.net.*;
import java.awt.*;
import java.util.*;
import java.applet.*;
import netscape.javascript.*;
/**

| * Asynchronously pushing pages to browsers. | |
|---|---|
| * The data can be pushed explicitly or data can be sent | |
| * by reference using a URL. | |
| * | |
| * The PushData signifies that it is an applet that | |
| * is waiting for push events. | |
| * | |
| * <P> | |
| * <B> PARAMETERS <BR> | |
| * | destwin = Destination Window's Name. <BR> |
| * | port = Port Number to connect to, default is the port of the originating Web server. |

<BR>

| | |
|---|---|
| * | desc = One Word Description of PushData applet.<BR> |

*/
public class PushData extends Applet implements Runnable
{

| protected int | port; |
|---|---|
| protected Socket | sock; |
| protected String | window = “_new”; |
| protected String | description; |
| protected Thread | runner; |
| protected boolean | threadRunning; |
| private DataInputStream in; | |
| private DataOutputStream out; | |
| private static int | defaultPort = −1; |

| | |
|---|---|
| // parameters | |
| private String targetWindow | = “destwin”; |
| private String portNumber | = “port”; |
| private String appletDesc | = “desc”; |

// Javascript Object
private JSObject mainwin;
/*

* Get all the necessary parameters.
* <ul>
* <li>port number
* <li>destination window
* <li>description
* </ul>

*/
public void init ()
{

URL url;
String str;
try
{

str = getParameter ( portNumber );
if ( str != null )

defaultPort= Integer.parseInt ( str );

}
catch (NumberFormatException e) { };
description = getParameter ( appletDesc );
window = this.getParameter ( targetWindow );
mainwin = JSObject.getWindow (this);

}
/**

* Gets called when loaded.

*/
public void start ()
{

runner = new Thread ( this );
threadRunning = true;
runner.start ();

}
/**

* Gets called when browser leaves window.

*/
public void stop ()
{

threadRunning = false;
closeSocket ();

}
/*

* Send/Receive messages from the server.

*/
public void run ()
{

int avail;
String data, message;
while ( threadRunning )
{

// open the connection to the server
openSocket ();
if ( !threadRunning )

break;

// notify anyone that the connection is open
connectionOpen ();
try
}

// open datastreams
in = new DataInputStream ( sock.getInputStream () );
out = new DataOutputStream ( sock.getOutputStream () );
// get the initial connection message
message = getConnectionMessage ();
if ( message !=null )

out.writeBytes ( message );

// send/receive messages
for ( ; threadRunning ; )
{

if ( sock == null ) // connection was broken

break;

if ( in.available () == 0 )
{

Thread.sleep ( 500 ); // check for data every 1/2 second
continue;

}
data = readAvailableData ( in );
if ( data == null ) // connection broken

break;

processMessage ( data.trim () );

}

}
catch ( Exception e )
{

System.out.println (e);

}
// notify that the connection was closed
connectionClosed ();

}

}
/**

* Gets called when browser is closed.

*/
public void destroy ()
{

closeSocket ();

}
/**

* Send a message to the server.
*
* @param String

*/
public void sendMessage ( String msg )
{

String data, message;
try
{

out.writeBytes ( msg );

}
catch ( Exception e )
{

System.out.println (“Send Exception: ” + e );

}

}
/**

* Process the message for this java applet.
* This can be overridden by other push applets
* to process the message differently.
* This method will push a URL into the destination window.
* If its just data, then we will send data to the window's
* JavaScript function <b>putText</b>.
*
* @param String

*/
public void processMessage ( String msg )
{

int offset;
URL url;
String data;
offset = msg.lastIndexOf ( ′ ′ );
if ( offset > 0 )

data = msg.substring ( 0, offset );

else

data = msg;

try
{

url = new URL ( data );
getAppletContext () .showDocument ( url, window );

}
catch ( MalformedURLException mue )
{

Object [] args = { msg };
mainwin.call ( “putText”, args );

}

}
/*

* This method will provide the connection
* message to be sent to the server when we
* are connected. This method can be overridden
* to provide your server specific protocol.
*
* @param String

*/
public String getConnectionMessage ()
{

return “PushData:connect:” + description;

}
/**

* Called when connection is opened.
* Override this method if you want to be notified
* on connection open.

*/
protected void connectionOpen ()
{
}
/**

* Called when connection is closed.
* Override this method if you want to be notified
* on connection closed.

*/
protected void connectionClosed ()
{
}
/*

* open the socket.

*/
protected void openSocket ()
{

URL url;
url = getCodeBase ();
while (threadRunning && url != null) // loop until socket is created
{

try
{

if ( defaultPort > 0 )

port = defaultPort;

else

port = url.getPort ();

sock = new Socket ( url.getHost (), port );
break;

}
catch (Exception e)
{

System.out.println ( “Error During Socket Open” );
System.out.println ( e );

}
try
{

Thread.sleep (5000);

}
catch ( InterruptedException ie )
{
}

}

}
/*

* Close the socket.

*/
protected void closeSocket ()
{

try
{

if ( sock != null )
{

sock.close ();
sock = null;

}

}
catch (Exception e)
{

System.out.println ( “Error During Socket Close” );
System.out.println ( e );

}

}
/**

* Read all the data that currently can
* be read off the pipe. The data.always
* starts with a length and then the data.
*
* @param DataInputStream
* @return String

*/
private String readAvailableData ( DataInputStream in )

throws IOException

{

int bytes, bytesRead=0;
byte [] b;
if ( in.available () > 0 )
{

bytes = in.readInt ();
b = new byte [ bytes ];
while ( bytesRead < bytes )
{

bytesRead += in.read ( b, bytesRead, bytes-bytesRead );

}

}
else

return null;

return new String ( b );

}

}

Having described the invention, what is claimed is:

1. A method for pushing information to a browser comprising:
embedding an applet in a web page;
providing said web page and embedded applet to a browser upon request for the web page; and, subsequent to providing said applet to said browser, providing unsolicited information to said browser.

2. The method according to claim 1 further comprising:
loading said applet in a memory of a computer running said browser; and, activating said applet.

3. The method according to claim 1 further comprising deactivating said applet in response to a closing of said web page.

4. The method according to claim 1 wherein said applet is a Java applet.

5. The method according to claim 1 further comprising said browser reactivating said applet upon receiving another web page with said applet embedded therein.

6. The method according to claim 1 further comprising hiding said applet within said web page.

7. A system for pushing information from a web server to a user browser comprising:
a web page;
a generic applet embedded within said web page;
wherein said generic applet is configured to allow unsolicited information to be pushed to a browser that downloads said web page.

8. The system according to claim 6 wherein said generic applet is a Java applet.

9. The system according to claim 6 wherein said Java applet is hidden.

10. The system according to claim 6 wherein said applet is configured to be activated and deactivated.

11. The system according to claim 6 wherein said web page is a plurality of web pages and said applet is embedded in at least two of said plurality of web pages.

12. A system for pushing information to a browser comprising:
applet means for opening a connection between a browser and a remote server; and,
carrier means for communicating said applet means to said browser;
wherein said applet means is generic to a plurality of dissimilar servers.

13. A method for pushing information to a browser comprising:
embedding a Java applet in an Internet web page;
providing said web page and said embedded applet to a browser upon request for the web page;
storing said applet in a memory associated with said browser;
activating said applet;
subsequent to activating said applet, providing unsolicited information to said browser from a remote server;
closing said web page; and, deactivating said applet in response to said closing.

14. The method according to claim 13 further comprising:
embedding said Java applet into another web page;
providing said another web page to said browser;
said browser reactivating said applet in response to detection of said applet embedded in said another web page.
